(19) United States
(12) Patent Application Publication
(10) Pub. No.: US 2025/0008259 A1
(43) Pub. Date: Jan. 2, 2025

(54) SOUNDING UNIT, LOUDSPEAKER AND ELECTRONIC DEVICE

(71) Applicant: Shenzhen VSUN Acoustics Co., Ltd., Shenzhen (CN)

(72) Inventors: Jiaping LIN, Shenzhen (CN); Feilong XU, Shenzhen (CN); Qingbin DONG, Shenzhen (CN)

(73) Assignee: Shenzhen VSUN Acoustics Co., Ltd., Shenzhen (CN)

(21) Appl. No.: 18/353,463

(22) Filed: Jul. 17, 2023

(30) Foreign Application Priority Data
Jun. 27, 2023 (CN) 202310775217.9

(51) Int. Cl. H04R 1/40

(52) U.S. Cl. CPC H04R 1/403

(57) ABSTRACT

The present invention discloses a sounding unit, a loudspeaker and an electronic device; wherein the sounding unit comprises a plurality of voice coils which are sequentially arranged in a horizontal direction, and current directions of adjacent voice coils at positions close to each other are opposite; each of the voice coils has a corresponding magnet steel, and polarities of the magnetic steels respectively corresponding to the adjacent voice coils are opposite, so that a force direction of each of the voice coils is the same, ensuring the consistency of the force of a plurality of voice coils; and since the voice coils are split, the force magnitude of the voice coils is effectively improved compared with the existing single voice coil arrangement mode, thereby greatly improving the sensitivity of the sounding unit and increasing the loudness of the sounding unit.

### CROSS-REFERENCE TO RELATED APPLICATIONS

The application claims priority to Chinese patent application No. 202310775217.9, filed on Jun. 27, 2023, the entire contents of which are incorporated herein by reference.

### TECHNICAL FIELD

The present invention relates to the field of sounding devices, in particular to a sounding unit, a loudspeaker and an electronic device.

### BACKGROUND

As a common electro-acoustic transducer device for converting electrical energy into acoustic energy, a sounding unit plays an indispensable role in acoustic amplification system.

With the wide application of consumer electronic products such as mobile phones and tablet computers, especially large-scale wearable electronic devices such as AR/VR, higher requirements are put forward on the light and thin appearance and performance of electronic devices. As an important component unit of such products, sounding units also put forward higher and higher requirements in terms of performance, size, etc.

However, the reduction of the volume of the magnetic circuit assembly of the micro-speaker and the reduction of the voice coil height due to the reduction of the B value and the voice coil L of the sound reduction of the sensitivity of the sounding unit and the reduction of the loudness due to the lightness of the sounding unit.

### SUMMARY

The technical problem to be solved by the present invention is to provide a sounding unit, a speaker and an electronic device, which can improve the sensitivity of the sounding unit.

In order to solve the above technical problem, one technical solution adopted by the present invention is:
a sounding unit comprising a plurality of voice coils;
wherein the plurality of voice coils are sequentially arranged in a horizontal direction, and current directions of adjacent voice coils at positions close to each other are opposite;
each of the voice coils has a corresponding magnet steel, and polarities of the magnetic steels respectively corresponding to the adjacent voice coils are opposite.

Further, adjacent voice coils are in contact with each other, and the current directions of the adjacent voice coils at a contact position are opposite.

Further, the plurality of voice coils are electrically and sequentially connected and have two output leads.

Further, the two output leads are centrosymmetric with respect to a central point of the plurality of voice coils.

Further, the plurality of voice coils are connected in parallel or in series.

The sounding unit further comprises a damper;
the plurality of voice coils are connected in parallel or in series via the damper.

Further, the damper has a pad adapted to each of the voice coils;
each of the voice coils corresponds to two of the pads; and
each of the voice coils is connected in parallel or in series with the other voice coils via two of the corresponding pads.

Further, the damper is arranged symmetrically.

Further, the damper is integrally formed or split into a plurality of grouped arrangements based on the pad.

Further, the magnet steel includes a central magnet steel;
the central magnet steel corresponding to each of the voice coils is provided inside the voice coil;
adjacent voice coils each have a central magnet steel of opposite polarity.

Further, the magnet steel further comprises a side magnet steel;
the side magnet steel corresponding to each of the voice coils is arranged around the outside of the voice coil;
the side magnet steel and the central magnet steel of each of the voice coils are opposite in polarity.

Further, the number of voice coils is two.

The sounding unit further comprises a basin frame;
the plurality of voice coils are provided in the basin frame and sequentially arranged along a short axis of the basin frame.

In order to solve the above technical problem, another technical solution adopted by the present invention is:
a loudspeaker comprising the sounding unit.

In order to solve the above technical problem, another technical solution adopted by the present invention is:
an electronic device comprising the loudspeaker.

The advantageous effect of the present invention is that by splitting to obtain a plurality of voice coils which are then sequentially arranged along a horizontal direction, and making the polarities of the magnetic steels respectively corresponding to the adjacent voice coils opposite, and making the polarity of the magnet steel corresponding to each adjacent voice coil opposite, it can be seen from the left-hand rule that the above-mentioned arrangement makes the force direction of each of the voice coils the same, ensuring the consistency of the force of the plurality of voice coils, and since the voice coils are split, with respect to the existing single voice coils arrangement, on the one hand, the utilization rate of the magnet steel is improved by splitting the middle region of the magnet steel, and on the other hand, under the same voice coils length, the plurality of voice coils have a longer circumference compared with a single voice coil, and accordingly, the thickness of the voice coils is reduced, so that the distance between adjacent magnet steels (side magnet steel and central magnet steel) becomes smaller, i.e., the magnetic gap becomes smaller, so that the magnetic attraction force is increased, and therefore, the force magnitude of the voice coils is increased, and therefore, the sensitivity of the voice coils to the external force is improved from the aspects of structural design and force design, so that the sensitivity of the sounding unit is greatly improved and the loudness of the sounding unit is increased.

### BRIEF DESCRIPTION OF DRAWINGS

FIG. 1 is a top view of a sounding unit according to an embodiment of the present invention;

FIG. 2 is a schematic diagram showing the structure of plane A-A in FIG. 1;

FIG. 3 is an enlarged schematic diagram showing B in FIG. 2;

FIG. 4 is an enlarged schematic diagram showing B in FIG. 2;

FIG. 5 is a schematic diagram showing a structure of a dual voice coil according to an embodiment of the present invention;

FIG. 6 is a schematic diagram showing the structure of a damper according to an embodiment of the present invention;

FIG. 7 is a schematic diagram showing the structure of a damper according to an embodiment of the present invention;

FIG. 8 is a schematic diagram showing a structure in which a dual voice coil is coupled to a damper according to an embodiment of the present invention;

FIG. 9 is a schematic diagram showing an integrally formed damper according to an embodiment of the present invention;

FIG. 10 is a schematic diagram showing a grouped damper according to an embodiment of the present invention;

FIG. 11 is a schematic diagram showing a structure in which an integrally formed damper is coupled to a dual voice coil according to an embodiment of the present invention;

FIG. 12 is a schematic diagram showing the structure of a grouped damper connected to a dual voice coil according to an embodiment of the present invention;

FIG. 13 is an exploded view of a speaker according to an embodiment of the present invention;

### DESCRIPTION OF REFERENCE NUMERALS

1. first voice coil; 2. second voice coil; 3. first central magnet steel; 4. second central magnet steel; 5. first side magnet steel; 6. second side magnet steel; 7. first central washer; 8. second central washer; 9. first side washer; 10. second side washer; 20. damper; 30. basin frame; 40. diaphragm; 50. dome; 60. magnetic shield; 11. first voice coil lead; 12. second voice coil lead; 21. third voice coil lead; 22. fourth voice coil lead; 111. first internal bonding pad; 121. second internal bonding pad; 211. third internal bonding pad; 221. fourth internal bonding pad; 112. first external bonding pad; 122. second external bonding pad; 212. third external bonding pad; 222. fourth external bonding pad.

### DETAILED DESCRIPTION OF THE EMBODIMENTS

In order to explain the technical contents, the objects, and the effects of the present invention in detail, the embodiments will be described below with reference to the accompanying drawings.

The above-mentioned sounding unit in the present application can improve the sensitivity of the voice coil to an external force condition, thereby improving the sensitivity of the sounding unit, and is particularly applicable to an application scenario requiring a high sensitivity of the sounding unit, such as a micro-speaker and an electronic device with a micro-speaker, such as a mobile phone, a tablet computer, etc. and the following is illustrated by embodiments:

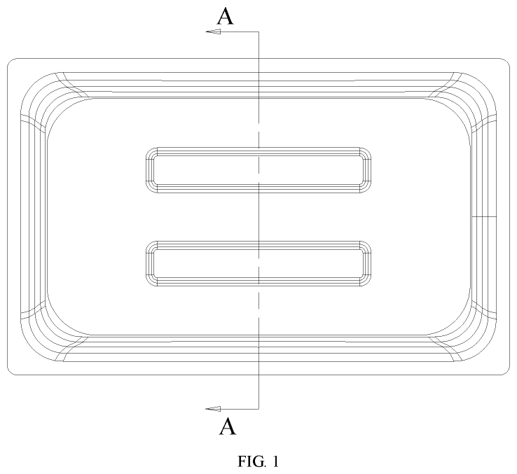

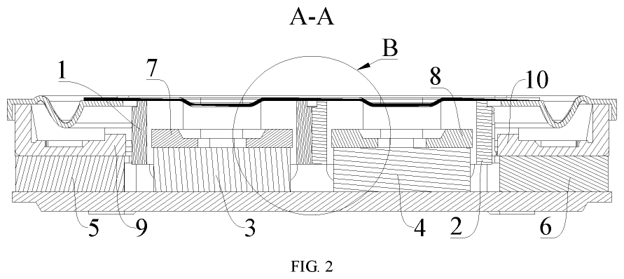

In an alternative embodiment, as shown in FIGS. 1-2, a sounding unit includes a plurality of voice coils;
the plurality of voice coils are sequentially arranged in a horizontal direction, and current directions of adjacent voice coils at positions close to each other are opposite, and in one implementation, the plurality of voice coils are sequentially arranged in a horizontal direction one by one;
each of the voice coils has a corresponding magnet steel, and polarities of the magnetic steels respectively corresponding to the adjacent voice coils are opposite.

In an alternative embodiment, where adjacent voice coils are in contact with each other and the current direction of the adjacent voice coils is opposite at the location of the contact, space is fully utilized by the adjacent voice coil contact arrangement, enabling maximization of the value of B and of the voice coil L in a limited space.

The number of voice coils is two or more, for example, two, three or four, etc.

In this implementation, two voice coils are provided, as shown in FIG. 2, comprising a first voice coil 1 and a second voice coil 2, wherein the first voice coil 1 and the second voice coil 2 are provided in contact.

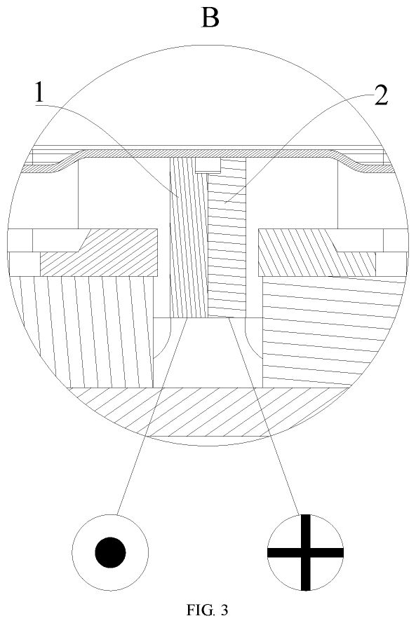

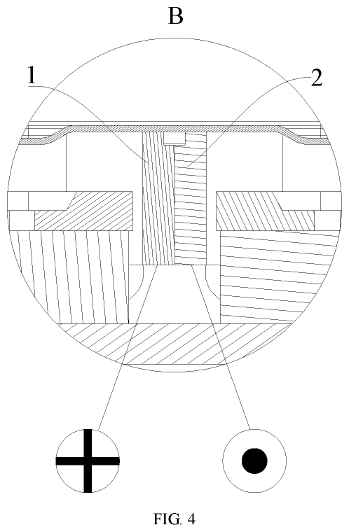

As shown in FIG. 3, in an alternative embodiment, the direction of current flow of the first voice coil 1 is perpendicular to a paper face outwards, and correspondingly, the direction of the current flow of the second voice coil 2 in contact with the first voice coil 1 is perpendicular to the paper face inwards; or, as shown in FIG. 4, in another alternative embodiment, the current direction of the first voice coil 1 is perpendicular to the paper face inwards, and correspondingly, the current direction of the second voice coil 2 in contact with the first voice coil 1 is perpendicular to the paper face outwards; thereby, it is ensured that the current directions of adjacent voice coils at a contact positions are opposite.

As shown in FIG. 2, the magnet steel corresponding to the first voice coil 1 comprises a first central magnet steel 3 and a first side magnet steel 5, and the magnet steel corresponding to the second voice coil 2 comprises a second central magnet steel 4 and a second side magnet steel 6.

The first central magnet steel 3 is arranged inside the first voice coil 1, i.e., the first voice coil 1 is arranged around the first central magnet steel 3, and the first side magnet steel 5 is arranged outside the first voice coil 1, i.e., the first side magnet steel 5 is arranged around the outside of the first voice coil 1; the second central magnet steel 4 is arranged inside the second voice coil 2, i.e., the second voice coil 2 is arranged around the second central magnet steel 4, and the second side magnet steel 6 is arranged outside the second voice coil 2, i.e., the second side magnet steel 6 is arranged around the outside of the second voice coil 2.

The polarity of the first central magnet steel 3 is opposite to that of the second central magnet steel 4, the polarity of the first side magnet steel 5 is opposite to that of the first central magnet steel 3, and the polarity of the second side magnet steel 6 is opposite to that of the second central magnet steel 4; for example, in an alternative embodiment, as illustrated in FIG. 2, the first central magnet steel 3 is magnetized from bottom to top through the first voice coil 1, the second central magnet steel 4 is magnetized from top to bottom through the second voice coil 2, the first side magnet steel 5 is magnetized from top to bottom, and the second side magnet steel 6 is magnetized from bottom to top.

In another alternative embodiment, the plurality of voice coils are electrically and sequentially connected, and have two output leads, that is to say, compared with each existing voice coil having two leads of a positive electrode and a negative electrode, in this embodiment, the plurality of voice coils are electrically and sequentially connected, and then the plurality of voice coils as a whole provide two output leads to the outside; with such an arrangement, the number of output leads is reduced compared with n voice coils having 2n output leads, the convenience of circuit connection is increased, thereby improving the ease of assembly of the whole machine, and the complexity of circuit connection is not caused by the introduction of the plurality of voice coil structure, thereby making the design of the plurality of voice coils more effective and reliable.

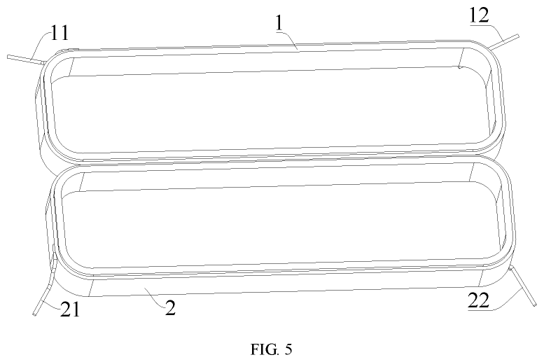

In order to further ensure the balance of the force exerted by the voice coils, in an alternative embodiment, the two output leads may be arranged to be centrosymmetric with respect to the central points of the plurality of voice coils, as shown in FIG. 5, the inherent lead of the first voice coil 1 comprises a first voice coil lead 11 and a second voice coil lead 12, the inherent lead of the second voice coil 2 comprises a third voice coil lead 21 and a fourth voice coil lead 22, and the two external output leads may be the second voice coil lead 12 and the third voice coil lead 21; the second voice coil lead 12 and the third voice coil lead 21 are centrosymmetric with respect to the central point of the rectangle surrounded by the first voice coil 1 and the second voice coil 2, and the other two leads are electrically connected inside the first voice coil lead 11 and the fourth voice coil lead 22; the two output leads to the outside can also be a first voice coil lead 11 and a fourth voice coil lead 22, the first voice coil lead 11 and the fourth voice coil lead 22 are centrosymmetric with respect to a central point of a rectangle surrounded by the first voice coil 1 and the second voice coil 2, and the other two leads are electrically connected inside the second voice coil lead 12 and the third voice coil lead 21.

In order to achieve electrical connection of the plurality of voice coils, in an alternative embodiment, the plurality of voice coils may be connected in parallel, and in another alternative embodiment, the plurality of voice coils may be connected in series.

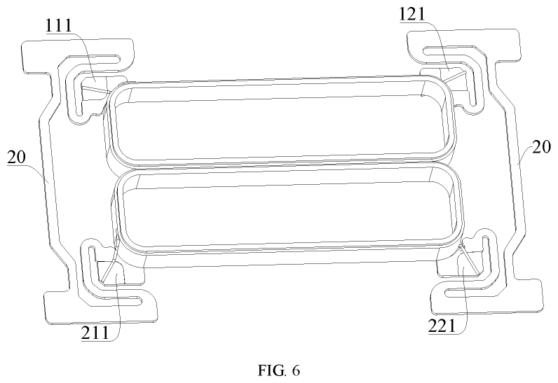

In order to achieve series or parallel connection of the voice coils, in an alternative embodiment, as shown in FIG. 6, a damper 20 is also included.

The plurality of voice coils are connected in parallel or in series via the damper 20; in particular, the damper has a pad adapted to each the voice coil;
each of the voice coils corresponds to two of the pads; and
each of the voice coils is connected in parallel or in series with the other voice coils via two of the corresponding pads; and
each pad comprises an internal bonding pad and a corresponding external bonding pad, the internal bonding pad is used for conducting with a lead of the voice coil, and the external bonding pad is used for conducting with an external circuit.

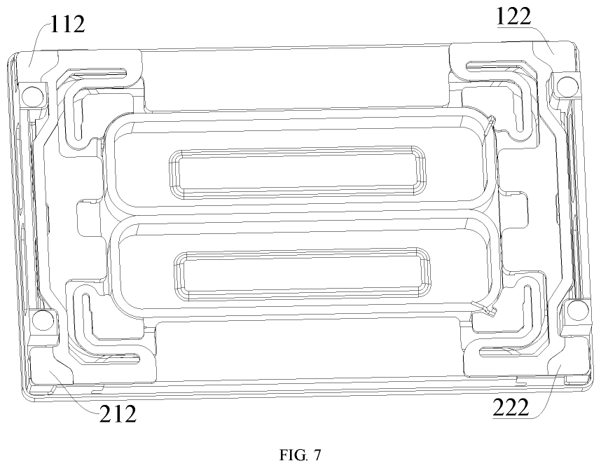

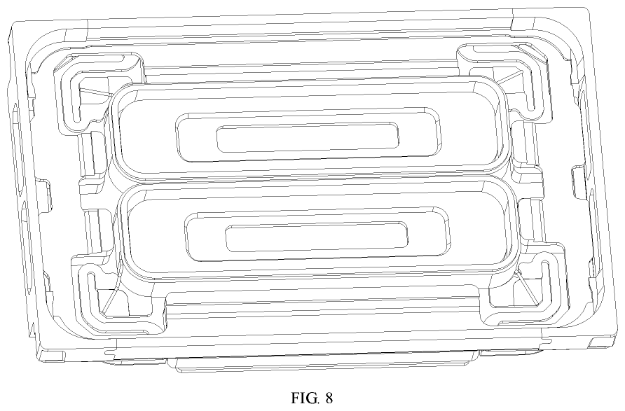

As shown in FIG. 6, the damper 20 comprises a first internal bonding pad 111 for conducting with the first voice coil lead 11, a second internal bonding pad 121 for conducting with the second voice coil lead 12, a third internal bonding pad 211 for conducting with the third voice coil lead 21 and a fourth internal bonding pad 221 for conducting with the fourth voice coil lead 22, and correspondingly, as shown in FIG. 7, the damper 20 further comprises a first external bonding pad 112 for conducting with the external circuit and a second external bonding pad 122 for conducting with the external circuit, third external bonding pad 212 for conducting with an external circuit and a fourth external bonding pad 222 for conducting with an external circuit, and FIG. 8 is a schematic diagram showing a sounding unit comprising a damper 20 after electrical connection is achieved.

In an alternative embodiment, in order to achieve the series connection of the first voice coil 1 and the second voice coil 2, as shown in the structure shown in FIGS. 6 and 7, an alternative connection method is:

a first external bonding pad 112-a third internal bonding pad 211-a third voice coil lead 21-a fourth voice coil lead 22-a second external bonding pad 122-a fourth external bonding pad 222-a second voice coil lead 12-a first voice coil lead 11-a third external bonding pad 212.

In an alternative embodiment, in order to achieve a parallel connection of the first voice coil 1 and the second voice coil 2, as shown in the structure shown in FIGS. 6 and 7, an alternative connection method is:
a first internal bonding pad 111-a first voice coil lead 11-a third internal bonding pad 211-a third voice coil lead 21-a first external bonding pad 112-a third external bonding pad 212;
a second internal bonding pad 121-a second voice coil lead 12-a fourth internal bonding pad 221-a fourth voice coil lead 22-a second external bonding pad 122-a fourth external bonding pad 222.

In this embodiment, the introduction of the damper allows the plurality of voice coils to be connected in series or in parallel on the one hand by the damper and to be in communication with the external FPC on the other hand, improving the flexibility of the plurality of voice coils circuit connection and also improving the stability of the plurality of voice coil structure.

In an alternative embodiment, the damper 20 is arranged symmetrically, thereby further ensuring the balance and stability of plurality of voice coils forces and increasing the sensitivity of the sounding unit.

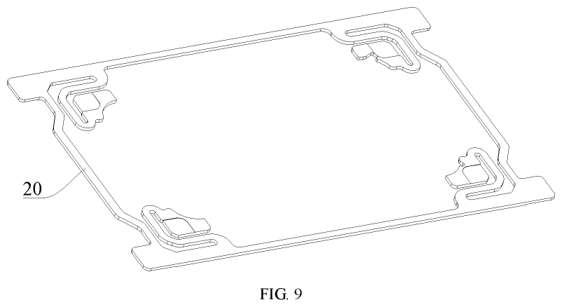

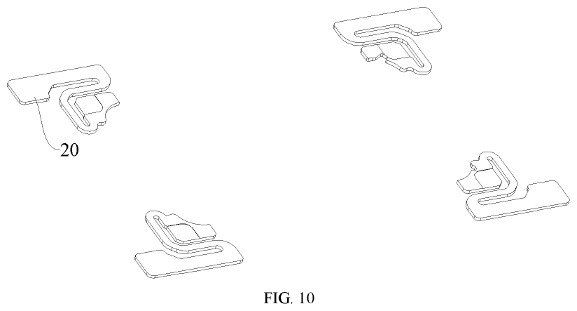

In another alternative embodiment, the damper 20 may be integrally formed, and as shown in FIG. 9, the damper 20 is a complete circle and is integrated into one body, and the serial connection and parallel connection of the voice coil are achieved by the wiring on the damper 20; it is also possible to split same into a plurality of grouped arrangements for example, two or four grouped arrangements based on the pad; as shown in FIG. 10, in this embodiment, the damper 20 is split into four pieces, respectively and conducts with the voice coil lead, and then is externally connected with a FPC to achieve series connection and parallel connection.

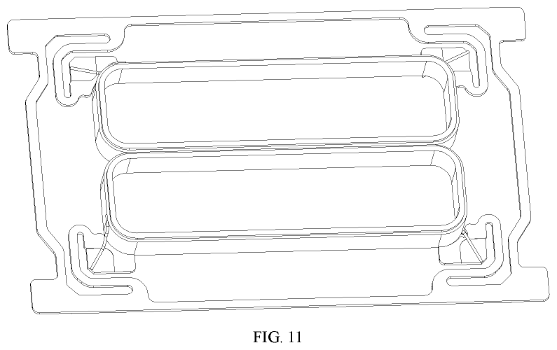

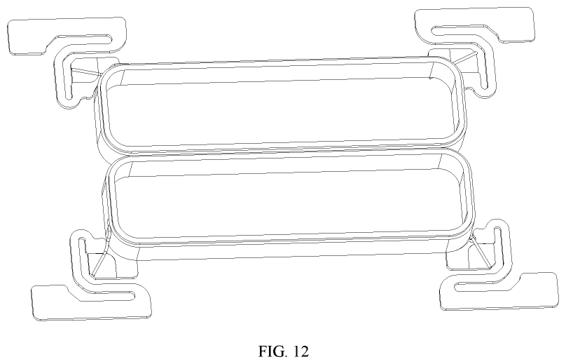

FIG. 11 is a schematic diagram showing a structure in which a damper 20 integrally formed is connected to a dual voice coil, and FIG. 12 is a schematic diagram showing a structure in which a damper 20 divided into four pieces is connected to a dual voice coil.

In this embodiment, by providing various forms of a damper, the connection mode of the plurality of voice coil structure is enriched, and the flexibility of the connection of the plurality of voice coil structure is improved.

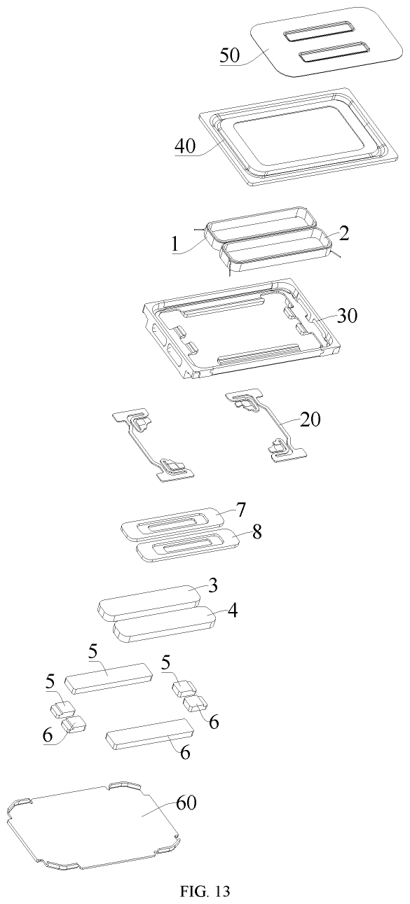

In another alternative embodiment, as shown in FIG. 13, a basin frame 30 is further included;
the plurality of voice coils are arranged in the basin frame 30, and are sequentially arranged along the direction of the short axis of the basin frame 30; by arranging the voice coils side by side along the direction of the short axis of the basin frame 30, the length of the voice coil can be made longer; the central magnet steel assembly is split into two along the direction of the long axis, and the length-width ratio is greater, which is more conducive to the use efficiency of the central magnet steel and improves the B value, thereby further improving the sensitivity of the sounding unit.

In another alternative embodiment, as shown in FIG. 13, a loudspeaker comprises a sounding unit in any of the above-mentioned embodiments. As shown in FIGS. 2 and 13, the loudspeaker comprises a dome 50, a diaphragm 40, a dual voice coil structure (comprising a first voice coil 1 and a second voice coil 2), a basin frame 30, a damper 20, a central washer (comprising a first central washer 7 and a second central washer 8), a side washer (comprising a first side washer 9 and a second side washer 10), and a central magnet steel (comprising a first central magnet steel 3 and a second central magnet steel 4), a side magnet steel (comprising the first side magnet steel 5 and the second side magnet steel 6) and a magnetic shield 60, which are arranged in a customary way as that in the field of loudspeakers, which will not be described in detail herein, and it can be seen from FIG. 13 that in this embodiment, the damper 20 is arranged in two groups.

In another alternative embodiment, an electronic device including the speaker described above, may be any portable electronic device, such as a cell phone, tablet computer, wearable device, etc.

In summary, the present invention provides a sounding unit, a loudspeaker and an electronic device, by dividing to obtain a plurality of voice coils which are sequentially arranged in a horizontal direction, polarities of the magnetic steels respectively corresponding to the adjacent voice coils are made opposite, the current directions of the adjacent voice coils at a contact positions are opposite, and the polarities of magnet steels corresponding to each of the adjacent voice coils are opposite. Based on the left-hand rule, it can be seen that the above-mentioned arrangement enables the force direction of each of the voice coils to be the same, ensuring the consistency of the force of the plurality of voice coils, and the adjacent voice coils are arranged in contact to make full use of space. The maximization of value B and the voice coil L can be achieved in a limited space, and at the same time, since the voice coils are split, with respect to the existing single voice coils arrangement, on the one hand, the utilization rate of the magnet steel is improved by splitting the middle region of the magnet steel, and on the other hand, under the same voice coils length, the plurality of voice coils have a longer circumference compared with a single voice coil, and accordingly, the thickness of the voice coils is reduced, so that the distance between adjacent magnet steels (side magnet steel and central magnet steel) becomes smaller, i.e., the magnetic gap becomes smaller, so that the magnetic attraction force is increased, and therefore, the force magnitude of the voice coils is increased; in addition, the electrical connection among the plurality of voice coils are achieved via the symmetrically arranged damper, so that the plurality of voice coils as a whole has only two point-symmetrical output leads to the outside, compared with n voice coils having 2n output leads, the number of output leads is reduced, the convenience of circuit connection is increased, thereby improving the ease of assembly of the whole machine, and the complexity of circuit connection will not be caused by the introduction of the structure of the plurality of voice coils. Therefore, the sensitivity of the voice coil to the external force is effectively improved from the comprehensive consideration of the mechanical structure design, circuit structure design and force design of the voice unit. Thus, the sensitivity of the sounding unit is greatly improved, and the loudness of the sounding unit is increased, which is particularly suitable for electronic device application scenarios with light and thin design requirements.

The above description is only an embodiment of the present invention, and is not intended to limit the scope of the present invention, and all equivalent modifications made by the present invention and the contents of the accompanying drawings, which are directly or indirectly applied to the related technical fields, are included in the scope of the present invention.

What is claimed is:

1. A sounding unit, comprising a plurality of voice coils;
wherein the plurality of voice coils are sequentially arranged in a horizontal direction, and current directions of adjacent voice coils at positions close to each other are opposite;
each of the voice coils has a corresponding magnet steel, and polarities of the magnetic steels respectively corresponding to the adjacent voice coils are opposite.

2. The sounding unit according to claim 1, wherein the adjacent voice coils are in contact with each other, and the current directions of the adjacent voice coils at a contact position are opposite.

3. The sounding unit according to claim 1, wherein the plurality of voice coils are electrically and sequentially connected and have two output leads.

4. The sounding unit according to claim 3, wherein the two output leads are centrosymmetric with respect to a central point of the plurality of voice coils.

5. The sounding unit according to claim 3, wherein the plurality of voice coils are connected in parallel or in series.

6. The sounding unit according to claim 5, further comprising a damper;
the plurality of voice coils are connected in parallel or in series via the damper.

7. The sounding unit according to claim 6, the damper has a pad adapted to each of the voice coils;
each of the voice coils corresponds to two of the pads; and
each of the voice coils is connected in parallel or in series with the other voice coils via two of the corresponding pads.

8. The sounding unit according to claim 7, wherein the damper is arranged symmetrically.

9. The sounding unit according to claim 7, wherein the damper is integrally formed or split into a plurality of grouped arrangements based on the pad.

10. The sounding unit according to claim 1, wherein the magnet steel comprises a central magnet steel;
the central magnet steel corresponding to each of the voice coils is provided inside the voice coil;
adjacent voice coils each have a central magnet steel of opposite polarity.

11. The sounding unit according to claim 10, wherein the magnet steel further comprises a side magnet steel;
the side magnet steel corresponding to each of the voice coils is arranged around the outside of the voice coil;
the side magnet steel and the central magnet steel of each of the voice coils are opposite in polarity.

12. The sounding unit according to claim 1, wherein the number of voice coils is two.

13. The sounding unit according to claim 1, further comprising a basin frame;
the plurality of voice coils are provided in the basin frame and sequentially arranged along a short axis of the basin frame.

14. A loudspeaker, comprising the sounding unit according to claim 1.

15. An electronic device, comprising the loudspeaker according to claim 14.
